(19) United States
(12) Patent Application Publication
(10) Pub. No.: US 2020/0139551 A1
(43) Pub. Date: May 7, 2020

(54) ROBOT SYSTEM

(71) Applicant: FANUC CORPORATION, Yamanashi (JP)

(72) Inventor: Masafumi OOBA, Yamanashi (JP)

(21) Appl. No.: 16/667,999

(22) Filed: Oct. 30, 2019

(30) Foreign Application Priority Data
Nov. 1, 2018 (JP) 2018-206548

(51) Int. Cl. B25J 9/16; B25J 9/00; B25J 19/02

(52) U.S. Cl. CPC B25J 9/1694; B25J 19/02; B25J 9/0084

(57) ABSTRACT

This robot system includes a sensor system that performs at least detection of a position of an object that is being moved by moving device, where the position of the object is detected based on data obtained by a sensor; a robot that performs a task on the object; a robot controller that controls the robot; and a measurement unit which is connected to the robot controller and which measures an amount of movement of the object moved by the moving device, in which the sensor system transmits a signal to the sensor when the sensor system causes the sensor to obtain the data, and the robot controller retains a value associated with a measurement value of the measurement unit when the robot controller receives the signal and associates the value with the position of the object detected by the sensor system.

### CROSS-REFERENCE TO RELATED APPLICATIONS

This application is based on and claims priority to Japanese Patent Application No. 2018-206548 filed on Nov. 1, 2018, the content of which is incorporated herein by reference in its entirety.

### FIELD OF THE INVENTION

The present invention relates to a robot system.

### BACKGROUND OF THE INVENTION

Traditionally, a robot system is known that includes a robot adapted to perform tasks on an object that is being moved by a transfer device, a robot controller adapted to control the robot, a vision system adapted to be controlled by the robot controller, and a measurement unit adapted to measure an amount of movement of the object moved by the transfer device, where the position of the object is detected within an image obtained by the vision system and the robot is controlled based on the position that has been detected and the amount of movement measured by the measurement unit (for example, see Japanese Unexamined Patent Application, Publication No. H11-90871).

### SUMMARY OF THE INVENTION

A robot system of an aspect of the present invention includes a sensor system that performs at least detection of a position of an object that is being moved by moving device, the sensor system detecting the position of the object based on data obtained by a sensor; a robot that performs a task on the object; a robot controller that controls the robot; and a measurement unit which is connected to the robot controller and which measures an amount of movement of the object moved by the moving device, wherein the sensor system transmits a signal to the sensor when the sensor system causes the sensor to obtain the data, and the robot controller retains a value associated with a measurement value of the measurement unit when the robot controller receives the signal, and the robot controller associates the value with the position of the object detected by the sensor system.

### BRIEF DESCRIPTION OF THE DRAWINGS

FIG. 1 is a diagram illustrating a configuration of a robot system of a first embodiment of the present invention.

FIG. 2 is a block diagram of a robot controller of the robot system of the first embodiment.

FIG. 3 is a flowchart illustrating an example of control of the robot system of the first embodiment.

FIG. 4 is a flowchart illustrating an example of control of a robot system of a second embodiment.

### DESCRIPTION OF EMBODIMENT(S) OF THE INVENTION

A robot system according to a first embodiment of the present invention will be described hereinbelow with reference to the drawings.

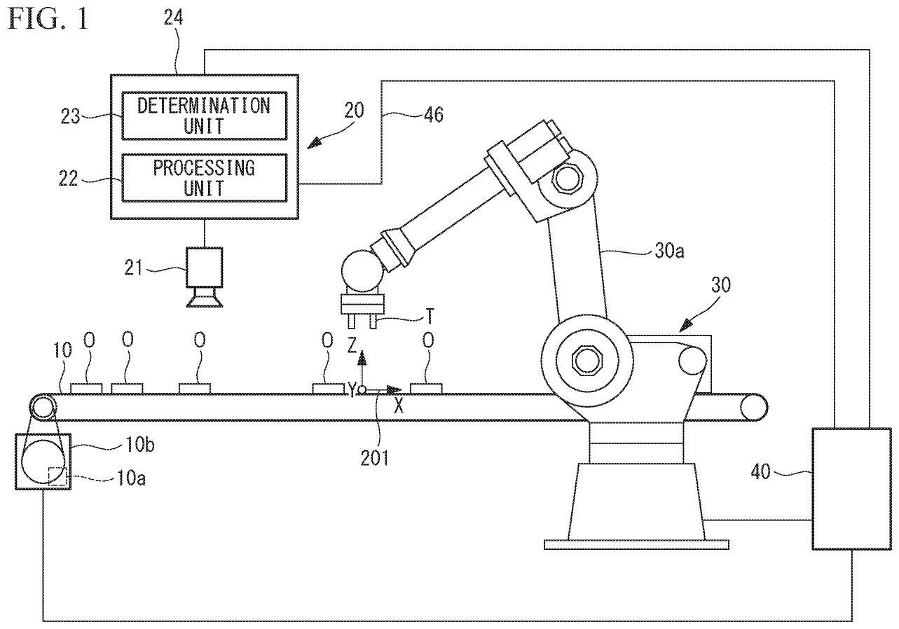

The robot system of this embodiment includes, as illustrated in FIG. 1, a transfer device 10 as moving means that moves objects O; a sensor system 20; a robot 30; and a robot controller 40 that controls the robot 30. The transfer direction of the transfer device 10 coincides with an X-axis direction of a robot coordinate system 201 of the robot 30, a direction perpendicular to a transfer surface of the transfer device 10 coincides with a Z-axis direction of the robot coordinate system 201, and a Y-axis direction of the robot coordinate system 201 is defined such that it coincides with a width direction parallel to a width of the transfer device 10. In this embodiment, the Z-axis direction is a vertical direction.

If the objects O are workpieces, the robot 30 carries out tasks such as unloading tasks and processing tasks on each of the objects O. The objects O may be holes formed in a single workpiece. In this case, the robot 30 carries out tasks such as processing and attachment of a component to each of the objects O.

The transfer device 10 includes a measurement unit 10a such as an encoder capable of detecting an amount of movement of the objects O that are being transferred. The measurement unit 10a is provided, for example, in a motor 10b that drives the transfer device 10. Alternatively, a roller may be provided at an end of the encoder and the roller may be pressed against a conveyor surface. The measurement unit 10a is connected to the robot controller 40 and the measurement values that are measured by the measurement unit 10a are constantly sent to the robot controller 40.

The sensor system 20 is, for example, a system for carrying out inspection of the objects O that are transferred by the transfer device 10. The sensor system 20 includes a sensor 21, a processing unit 22 that processes data obtained by the sensor 21, and a determination unit 23 that carries out determination using the data that has been obtained and processed by the processing unit 22. The processing unit 22 and the determination unit 23 are provided, for example, in a sensor controller 24.

It should be noted that the processing unit 22 and the determination unit 23 may be incorporated into the sensor 21.

The sensor 21 should be capable of obtaining data for detecting positions of the objects O and is, for example, a two-dimensional camera, a three-dimensional camera, a three-dimensional distance sensor, etc. In this embodiment, the sensor 21 is arranged above the transfer device 10.

The sensor controller 24 has a processor such as a CPU, a storage unit such as non-volatile storage, ROM, and RAM units, an input unit such as a keyboard and the like, a display unit, etc., and is connected to the robot controller 40. The processing unit 22 and the determination unit 23 are configured by the processor that operates based on programs stored in the storage unit.

The above-mentioned inspection may be any appropriate inspection, the processing unit 22 creates the processed data by performing known image processing, and the determination unit 23 carries out pass/fail judgment as part of, for example, component inspection or product inspection on each of the objects O based on the data that has been processed.

Also, the processing unit 22 or the determination unit 23 detects at least the positions of the objects O using the data that has been processed or has not been processed. As the processing includes image processing, matching processing, and the like, the processing cycle of the processing is 100 milliseconds or more in many cases and the control cycle of the processing will be longer than that if the sensor 21 obtains three-dimensional data. It should be noted that the processing unit 22 or the determination unit 23 may detect the positions and orientations of the objects O.

The position detected for each of the objects O may be a position of the object O in the data obtained by the sensor 21 or a position of the object O in the data that has been processed. In this case as well, the processing that will be described later can be performed if the robot controller 40 recognizes the positions in the robot coordinate system of these positions.

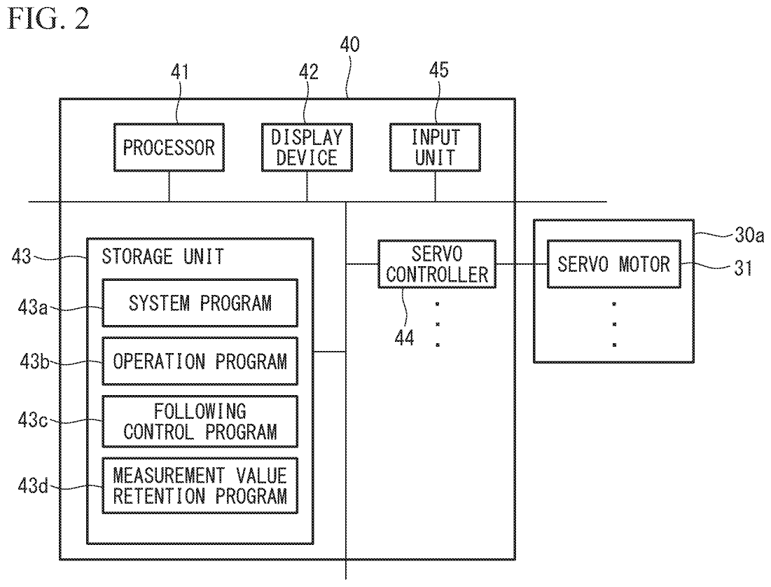

While the robot 30 is not limited to a robot of a particular type, the robot 30 of this embodiment is a vertical articulated robot that includes servo motors 31 (see FIG. 2) that individually drive multiple movable parts. It should be noted that the multiple movable parts constitute an arm 30a of the robot 30. The servo motors 31 each have an operation position detection device that detects the position of actuation thereof and the operation position detection device is, as an example, an encoder. The detected value that is detected by the operation position detection device is transmitted to the robot controller 40. The robot 30 may be a horizontal articulated robot, a multi-link robot, etc.

The robot controller 40 includes, according to an example, as illustrated in FIG. 2, a processor 41 such as a CPU, a display device 42, a storage unit 43 that has a non-volatile storage unit, a ROM unit, a RAM unit, etc., a plurality of servo controllers 44 that corresponds to the servo motors 31 of the robot 30, respectively, and an input unit 45 such as an operation panel.

A system program 43a is stored in the storage unit 43 and the system program 43a is responsible for the basic functions of the robot controller 40. Also, an operation program 43b and a following control program 43c are stored in the storage unit 43 and the processor 41 controls the individual servo motors 31 of the robot 30 and a tool T provided at the distal end of the robot 30 based on these programs, by means of which the robot 30 performs tasks on the objects O that are being transferred by the transfer device 10. Also, a measurement value retention program 43d is stored in the storage unit 43.

In this embodiment, a detection area by the sensor 21 is arranged on an upstream side in the transfer direction of the transfer device 10 relative to a work area of the robot 30, and the detection area and the work area do not overlap each other. The work area is not an area where the robot 30 is allowed to move but an area where the robot 30 carries out the above-mentioned task. It should be noted that the detection area and the work area may partly overlap each other.

The robot controller 40 is designed for controlling the robot 30 and, as a result, the robot controller 40 recognizes the robot coordinate system 201 that is the coordinate system of the robot 30. The robot controller 40 recognizes the positions and orientations of the individual movable parts of the arm 30a of the robot 30 and tool T in the robot coordinate system 201 and controls the individual servo motors 31 and the tool T at the distal end of the robot 30.

Here, in order to carry out the control (tracking control) to cause the tool T at the distal end of the robot 30 to follow the object O that is being transferred by the transfer device 10 using the position data indicative of the positions of the individual objects O that are detected by the sensor system 20, it is necessary to transmit detected positions of the individual objects O or information associated therewith in a timely manner from the sensor system 20 to the robot controller 40, but the sensor system 20 does not have such a function.

As a compared example, a vision system for use in control of the robot 30 will be described. The vision system is manufactured by a robot manufacturing company that manufactures the robot 30 and the robot controller 40 and is specialized for control of the robot 30. In general, robot controller 40 and the vision system are created such that they are compatible with each other. In addition, information, data, etc., obtained by the vision system are suitable for use on the robot controller 40, and the information regarding imaging by the vision system and other necessary pieces of information and the like are transmitted to the robot controller 40 in a timely manner. In addition, the robot controller 40 carries out the tracking control based on the data received from the vision system.

Meanwhile, the sensor system 20 is manufactured by a company specialized for manufacturing thereof, and the sensor 21 and the sensor controller 24 are for use in the inspection and not for use in control of the robot 30. This also applies to a case where the sensor system 20 is used in applications other than the inspection. The sensor system 20 of this type includes specifications and interfaces suited for its applications, and the processing performed in the sensor 21 and sensor controller 24 of the sensor system 20 is also specialized for the above-mentioned applications. As a result, the sensor system 20 cannot provide in a timely manner information, data, etc., suitable for control of the robot 30. In the above-described situation, employing a vision system for use in control of a robot is in normal cases considered.

However, the sensor system 20 and the sensor 21 specialized for specific applications such as inspection may in some cases have functions superior to those of the vision system for control of the robot 30. For example, such cases may include a case where the sensor 21 is a high-precision sensor, a case where the processing in the processing unit 22 is high-precision processing, a case where the sensor system 20 is capable of obtaining information that cannot be obtained by the vision system, and any other relevant cases. In this embodiment, outputs from the sensor system 20 are used in the control to cause the tool T at the distal end of the robot 30 to follow the object O.

For this reason, in this embodiment, as illustrated in FIG. 1, a signal line 46 is provided such that it interconnects the signal path, which exists between the sensor controller 24 and the sensor 21 of the sensor system 20, and the robot controller 40. The above-mentioned signal path is adapted to send a trigger signal from the sensor controller 24 to the sensor 21. The signal path includes a board that issues the trigger signal, a signal line interconnecting the board and the sensor 21, and the like.

For example, one end of the signal line 46 is connected to a predetermined connection unit of the robot controller 40, and the other end of the signal line 46 is connected to the signal path. Also, assignment of the signal line connected to the above-described predetermined connection unit is input to the input unit 45 of the robot controller 40. A configuration user interface for setting to indicate the fact that the signal line 46 is for use in inputting the signal that will be described later may be provided on the input unit 45.

It should be noted that the signal line 46 may be connected to the sensor controller 24 as illustrated in FIG. 1. The sensor controller 24 sends a step signal to the camera for its exposure and the signal may be put into the robot controller 40. Alternatively, the sensor controller 24 is capable of outputting a strobe signal for turning on a lighting device at the imaging time point and the signal may be put into the robot controller 40. The bottom line is that a signal that maintains punctuality with reference to the exposure of the camera 21 should be input to the robot controller 40. Correction of the measurement value of the measurement unit 10a is possible if the conveyor speed is basically constant and the delay is substantially at a constant level.

It should be noted that, while wiring is performed physically independently here, signals may be input to the robot controller 24 via a connection line interconnecting the sensor controller 24 and the robot controller 40, for example, via Ethernet. For example, Ethernet provides various protocols and fieldbuses for industrial applications. Fieldbuses may include one that is capable of exchanging data at high frequency, making it possible to output signals in accordance with the exposure time point in a simulated manner. The measurement value of the measurement unit 10a may be retained using this signal. It is possible to perform correction (calculation) of the measurement value of the measurement unit 10a if the conveyor speed is basically constant and the delay is substantially at a constant level. When the calculation is performed, the value after the calculation is retained.

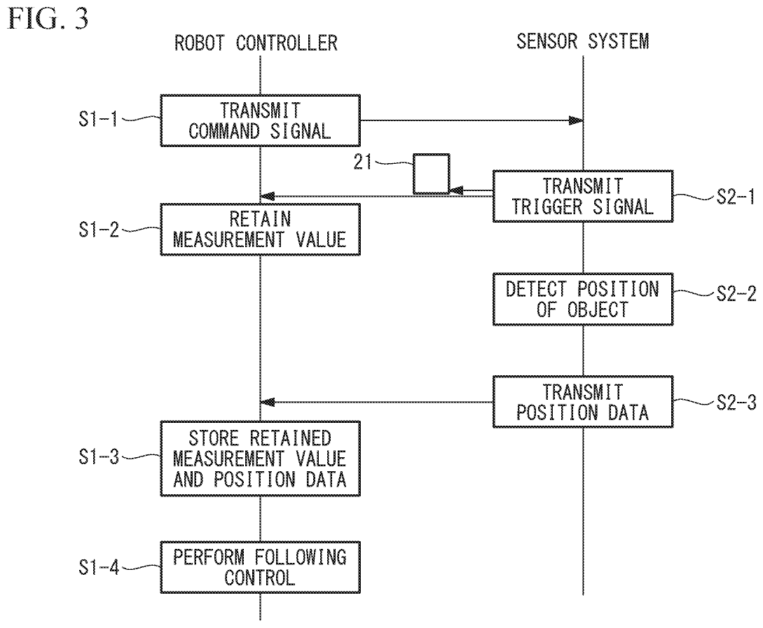

In this embodiment, the processing by the robot controller 40 and the sensor system 20 in the case where the control to cause the tool T at the distal end of the robot 30 to follow the object O is carried out in a state where the objects O are being transferred by the transfer device 10 will be described with reference to the flowchart of FIG. 3.

When the operation for carrying out a task on the object O is started, the robot controller 40 transmits command signals for causing the sensor system 20 to perform detection of the position of the object O (step S1-1). As a result, the sensor system 20 sends a trigger signal to the sensor 21 and the robot controller 40 (step S2-1), the processing unit 22 or the determination unit 23 detects at least the position of each of the objects O using the data obtained by the sensor 21 (step S2-2), and transmits the position data indicative of the position that has been detected to the robot controller 40 (step S2-3). It should be noted that step S1-1 may not be performed and steps S2-1 and S2-2 may be executed for each predetermined time period or for each predetermined distance by inputting of the encoder that is identical or different than the robot into the sensor system 20. Alternatively, a photoelectric sensor may be separately provided and the command signal may be sent with the detection of the photoelectric sensor as a trigger. Also, in step S2-3, the position data may include the orientation data indicative of the orientation of each of the objects O.

It should be noted that the command signals should be transmitted by certain communication means provided by the sensor system. For example, it may be a command message via Ethernet or a command signal may be sent through interconnection between the robot controller 40 and the sensor system.

Here, as the signal line 46 is provided such that it interconnects the signal path, which exists between the sensor controller 24 and the sensor 21, and the robot controller 40, a predetermined signal is transmitted via the signal line 46 to the robot controller 40 when the sensor system 20 sends the trigger signal to the sensor 21. In this embodiment, the predetermined signal is the above-described trigger signal. The trigger signal may be a step signal for data acquisition by the sensor 21, a trigger signal of a lighting device by the sensor 21, and the like. As a result, the robot controller 40 receives the above-described signal simultaneously with or substantially simultaneously with the data acquisition by the sensor 21.

The robot controller 40 retains, based on the measurement value retention program 43d, the measurement value of the measurement unit 10a at the time of reception of the signal (step S1-2). It should be noted that, if the measurement value of the measurement unit 10a is corrected (calculated) as discussed above, then the value after the calculation is retained in place of the measurement value. In other words, it suffices that the value associated with the measurement value is retained and, in step S1-2, the value associated with the measurement value is the measurement value itself. If the control cycle at which the robot controller 40 controls the robot 30 is, for example, about 10 milliseconds, then it is preferable that the processing cycle of the robot controller 40 for the process at step S1-2 be shorter than that.

Alternatively, the time point at which the reception was performed may be recorded by interrupt handling processing, the encoder values may be recorded using the recorded time point as the border defining two sections, linear interpolation may be performed on the interval to calculate the encoded value at the time point of the reception. A value that has been determined in this manner is also a value associated with the measurement value.

Alternatively, a signal may be transmitted in advance on a side of the sensor system, taking the delay into account.

Meanwhile, the robot controller 40 receives the position data of each of the objects O from the sensor system 20 and stores, in the storage unit 43, the position data that has been received for each of the objects O and the retained measurement value (step S1-3). At the time of storing in the storage unit 43, the position data of each of the objects O is associated with the retained measurement value.

It should be noted that, in a case of a tracking system that does not need precision, after step S1-1 or in accordance with step S1-1, the measurement value of the measurement unit 10a may be recorded and associated with the results that have been sent at step S2-3.

It should be noted that the transmission and reception of the above-described signal and the above-described data between the robot controller 40 and the sensor system 20 should be performed such that they are transmitted and received by certain communication means provided by the sensor system. For example, it may be a message via Ethernet or may be a pseudo group signal utilizing a fieldbus, and a group signal may be received by interconnection between the robot controller and the sensor system. Here, the group signal is defined such that the signals each correspond to corresponding one bit of 16 bits.

The robot controller 40 carries out the control to cause the tool T at the distal end of the robot 30 to follow the object O based on the following control program 43c and using the position data of the object O on which the task is going to be performed and using the difference between the measurement value retained with regard to this object O and the current measurement value of the measurement unit 10a (step S1-4), and the task by the robot 30 is performed on the object O.

It should be noted that, in a case where the sensor system 20 has detected multiple objects before the robot 30 performs the task, the robot controller 40 may implement queue management on these objects.

Subsequently, a robot system according to a second embodiment of the present invention will be described hereinbelow with reference to the drawings. The robot system of the second embodiment, which is one that is in the context of the first embodiment, is configured such that the communications between the sensor system 20 and the robot controller 40 are performed via a host controller 50. In the second embodiment, the same features as those in the first embodiment are assigned the same reference signs with explanations thereof omitted.

The robot system of the second embodiment has the transfer device 10, the sensor system 20, the robot 30, and the robot controller 40 that have a configuration which is the same as or similar to those in the first embodiment, and further includes a host controller 50 to which the sensor system 20 and the robot controller 40 are connected.

The host controller 50 is, for example, a server computer or a programmable logic controller (PLC) and has a production management function. The inspection result and the detection result of the sensor system 20 is sent to the host controller 50 and, in the host controller 50, accumulation of the inspection results and the like are performed. Also, information associated with the task is transmitted from the robot controller 40 to the host controller 50. Meanwhile, various command signals associated with production are sent from the host controller 50 to the sensor system 20 and the robot controller 40.

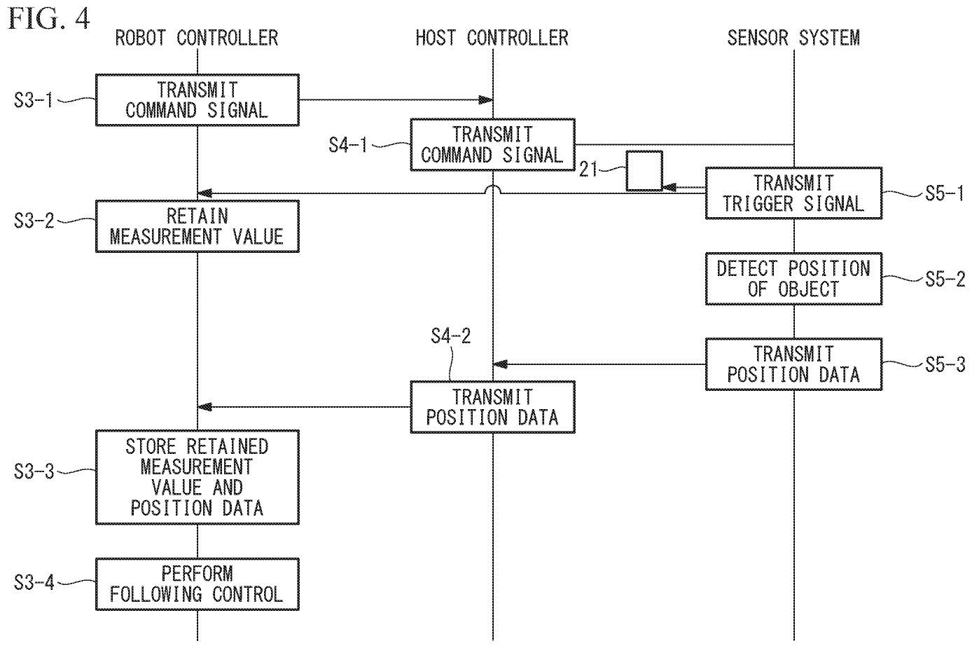

In the second embodiment, the processing of the robot controller 40 in the case where the control to cause the tool T at the distal end of the robot 30 to follow the object O is to be carried out in the state where the objects O are being transferred by the transfer device 10 will be described with reference to the flowchart of FIG. 4.

When the operation for carrying out a task on the objects O is started, the robot controller 40 transmits a command signal for causing the host controller 50 to perform detection of the positions of the objects O (step S3-1), and a command signal is transmitted from the host controller 50 to the sensor system 20 (step S4-1). As a result, the sensor system 20 sends a trigger signal to the sensor 21 and the robot controller 40 (step S5-1) and the processing unit 22 or the determination unit 23 detects at least the position of each of the objects O using the data obtained by the sensor 21 (step S5-2) and transmits the position data indicative of the position that has been detected to the host controller 50 (step S5-3). The host controller 50 transmits the position data that has been received to the robot controller 40 (step S4-2).

In the manner which is the same as or similar to the first embodiment, as the signal line 46 that interconnects the signal path, which connects the sensor controller 24 and the sensor 21, and the robot controller 40 is provided, a predetermined signal (signal) is transmitted via the signal line 46 to the robot controller 40 when the sensor system 20 sends the trigger signal to the sensor 21. As a result, the robot controller 40 receives the above-described signal simultaneously with or substantially simultaneously with data acquisition by the sensor 21.

The robot controller 40 retains, based on the measurement value retention program 43d, the measurement value of the measurement unit 10a at the time of reception of the signal (step S3-2). The value after the calculation may be retained in the same manner as in the first embodiment. Meanwhile, the robot controller 40 receives, from the host controller 50, the position data of each of the objects O that has been detected by the sensor system 20 and stores, in the storage unit 43, the position data that has been received for each of the objects O and the retained measurement value (step S3-3). At the time of storing in the storage unit 43, the position data of each of the objects O is associated with the retained measurement value.

The robot controller 40 carries out the control to cause the tool T at the distal end of the robot 30 to follow the object O based on the following control program 43c and using the position data of the object O on which the task is going to be performed and using the difference between the measurement value retained with regard to this object O and the current measurement value of the measurement unit 10a (step S3-4), and the task by the robot 30 is performed on the object O.

In the first and second embodiments, when the sensor system 20 causes the sensor 21 to acquire data, the sensor system 20 transmits a signal, and the robot controller 40 retains the value associated with the measurement value of the measurement unit 10a at the time of reception of the signal. Also, the position of the object O detected by the sensor system 20 is associated with the retained value associated with the measurement value. As a result, it is made possible to carry out accurate tracking control of the robot 30 even when a delay occurs in the position detection of the object O by the sensor system 20 or a delay or the like in the information transmission from the sensor system 20 to the robot controller 40.

Also, in the second embodiment, the host controller 50 is included that is connected to the sensor system 20 and the robot controller 40, and the robot controller 40 receives, via the host controller 50, the information on the position detected by the sensor system 20.

The communications between the sensor system 20 and the robot controller 40 via the host controller 50 are more likely to be delayed as compared with direct communications between the sensor system 20 and the robot controller 40. In this aspect, when the sensor system 20 causes the sensor 21 to acquire data, the sensor system 20 transmits a signal and the robot controller 40 retains the value associated with the measurement value of the measurement unit 10a at the time of reception of the signal. As a result, even in a case where the sensor system 20 and the robot controller 40 perform communications via the host controller 50, it is made possible to carry out accurate tracking control of the robot 30.

Also, in the first and second embodiments, the user interface for setting is provided in the input unit 45 for setting to indicate the fact that one end of the signal line 46 is connected to a predetermined connection part of the robot controller 40 and the signal line 46 is for use in inputting of the signal that will be described later. As a result, it is made possible to pursue facilitated connection work for connection to the robot controller 40 and accurate tracking control of the robot 30 at the same time.

It should be noted that, in the first and second embodiments, the sensor system 20 may detect quality information indicative of a quality and shape information indicative of a shape of the object O based on the data that has been obtained by the sensor 21. The quality information and the shape information may be a quality-related score indicating the quality of the object O. Examples of the quality-related score may include a degree of conformity between the shape or color of the object O that has been detected and the shape or color of a predetermined model. For example, if the object O is a fresh food, the shape and color of the object O changes depending on a degree of freshness and presence or absence of deterioration. Also, the quality information may be a task-related score indicative of a degree of difficulty of the task of the robot 30 on the object O. For example, task efficiency changes depending on the object O.

In addition, in the first and second embodiments, the robot controller 40 may store the retained value associated with the measurement value, the position detected by the sensor system 20, and the quality information or shape information and define the correspondence between the retained value associated with the measurement value and the detected position as well as the quality information or shape information.

The sensor system 20 that is manufactured by a manufacturing company or the like of inspection devices and high-precision measurement instruments may be in some cases superior in detection of the quality information of the object O. By virtue of the feature, the quality information and the shape information detected by the sensor system 20 are associated with the retained value associated with the measurement value. As a result, it is made possible to implement accurate determination and the like using the quality information and the shape information obtained by the sensor system 20 and, for example, it is made possible to carry out an unloading task by the robot 30 starting from the one having a low quality.

It should be noted that in the first and second embodiments, the sensor 21 may be supported by the robot 30 or any other robot. In this case, the robot controller 40 retains the operation information of the robot 30 or the other robot at the time of reception of the signal and defines the correspondence between the operation information that has been retained and the retained value associated with the measurement value. The operation information may be the detected value of the operation position detection device of each servo motor 31. According to this feature, since the robot controller 40 recognizes the position of the sensor 21 at the time of acquisition of data by the sensor 21, it is made possible to carry out accurate tracking control of the robot 30.

Also, in the first and second embodiments, it is also possible to use, as the moving means that moves the object O, in place of the transfer device 10, a robot that moves the object O, a moving cart that moves the object O placed thereon as a result of the movement of the same moving cart, or any other relevant units. If a robot is used, in place of the measurement value of the measurement unit 10a, detected values that are detected by the operation position detection devices of the servo motors of the robot may be used in some cases as the measurement value of the amount of movement of the object O. The robot controller 40 retains the detected values of the operation position detection devices in the storage unit in response to reception of a signal.

In a case where the moving cart is used, in place of the measurement unit 10a, a detected value of an encoder of a motor that drives the moving cart is used as the measurement value of the amount of movement of the object O. The robot controller 40 retains the detected value of the encoder of the motor of the moving cart in the storage unit 43 in response to reception of a signal.

It should be noted that, in place of the measurement unit 10a, an indicator provided on the transfer device 10, the amount of movement of the object O or the like may be detected by a sensor such as a two-dimensional camera. In this case, the sensor such as a two-dimensional camera functions as the measurement unit.

The following aspects of the present invention are derived from the above disclosure.

A robot system of an aspect of the present invention includes a sensor system that performs at least detection of a position of an object that is being moved by moving device, the sensor system detecting the position of the object based on data obtained by a sensor; a robot that performs a task on the object; a robot controller that controls the robot; and a measurement unit which is connected to the robot controller and which measures an amount of movement of the object moved by the moving device, wherein the sensor system transmits a signal to the sensor when the sensor system causes the sensor to obtain the data, and the robot controller retains a value associated with a measurement value of the measurement unit when the robot controller receives the signal, and the robot controller associates the value with the position of the object detected by the sensor system.

According to the above-mentioned aspect, when the sensor system causes the sensor to acquire data, the sensor system transmits a signal, and the robot controller retains the value associated with the measurement value of the measurement unit at the time of reception of the signal. Also, the correspondence is established between the position of the object detected by the sensor system and the value associated with the retained measurement value. As a result, it is made possible to carry out accurate tracking control of the robot even when a delay occurs in the position detection of the object by the sensor system or a delay or the like in the information transmission from the sensor system to the robot controller.

It should be noted that the measurement value may be corrected for taking into account the delay of the time point at which the measurement value of the measurement unit is obtained with respect to the time point of data acquisition by the sensor.

Also, if accurate tracking control is not necessary, the measurement value of the measurement unit may be retained at the time point at which the robot controller sends the signal of activation to the sensor system.

In the above-mentioned aspect, preferably, the sensor system detects quality information or shape information of the object based on the data obtained by the sensor, and the robot controller makes the retained value correspond to the position detected by the sensor system and the quality information or the shape information.

The sensor system that is manufactured by a manufacturing company or the like of inspection devices and high-precision measurement instruments may be in some cases superior in detection of the quality information and the shape information of the object. In this aspect, the correspondence is established between the retained value associated with the measurement value and the quality information and the shape information detected by the sensor system, so that it is made possible to implement accurate determination and the like using the quality information obtained by the sensor system.

In the above-mentioned aspect, preferably, a host controller is provided that is connected to the sensor system and the robot controller, and the robot controller receives the information on the position detected by the sensor system via the host controller.

The communications between the sensor system and the robot controller via the host controller are more likely to be delayed as compared with the direct communications between the sensor system and the robot controller. In this aspect, when the sensor system causes the sensor to acquire data, the sensor system transmits a signal, and the robot controller retains the value associated with the measurement value of the measurement unit at the time of reception of the signal. As a result, even in a case where the sensor system and the robot controller perform communications via the host controller it is made possible to carry out accurate tracking control of the robot.

It should be noted that, in this case as well, the measurement value may be corrected for taking into account the delay of the time point at which the measurement value of the measurement unit is obtained with respect to the time point of the data acquisition by the sensor.

Also, if accurate tracking control is not necessary, the measurement value of the measurement unit may be retained at the time point at which the robot controller sends the signal of activation to the sensor system.

In the above-mentioned aspect, preferably, the sensor is supported by the robot or another robot, and the robot controller retains operation information of the robot or the other robot when the robot controller receives the signal, and the robot controller associates the retained operation information with the retained value.

It should be noted that, in this case as well, the measurement value may be corrected for taking into account the delay of the time point at which the measurement value of the measurement unit is obtained with respect to the time point of the data acquisition by the sensor.

In this aspect, the sensor system is not a system manufactured for use in control of the robot and the sensor is supported by the robot or the other robot. However, the correspondence is established between the value associated with the measurement value of the measurement unit at the time when the position detection of the object by the sensor system was performed and the operation information of the robot or the other robot, so that it is made possible to carry out accurate tracking control of the robot.

According to the above aspects, it is made possible to achieve accurate tracking control of a robot using a sensor system manufactured by a manufacturing company or the like of an inspection device.

1. A robot system comprising:
a sensor system that performs at least detection of a position of an object that is being moved by moving device, the sensor system detecting the position of the object based on data obtained by a sensor;
a robot that performs a task on the object;
a robot controller that controls the robot; and
a measurement unit which is connected to the robot controller and which measures an amount of movement of the object moved by the moving device, wherein
the sensor system transmits a signal to the sensor when the sensor system causes the sensor to obtain the data, and
the robot controller retains a value associated with a measurement value of the measurement unit when the robot controller receives the signal, and the robot controller associates the value with the position of the object detected by the sensor system.

2. The robot system according to claim 1, wherein
the sensor system detects quality information or shape information of the object based on the data obtained by the sensor, and
the robot controller makes the retained value correspond to the position detected by the sensor system and the quality information or the shape information.

3. The robot system according to claim 1, further comprising a host controller connected to the sensor system and the robot controller, wherein
the robot controller receives information on the position detected by the sensor system via the host controller.

4. The robot system according to claim 1, wherein
the sensor is supported by the robot or another robot, and
the robot controller retains operation information of the robot or the other robot when the robot controller receives the signal, and the robot controller associates the retained operation information with the retained value.
